(19) United States
(12) Patent Application Publication
(10) Pub. No.: US 2016/0041718 A1
(43) Pub. Date: Feb. 11, 2016

(54) REMOTE CONTROL ARRANGEMENT

(71) Applicant: XPED HOLDINGS PTX LTD, South Australia (AU)

(72) Inventors: Christopher Richard Wood, Mawson Lakes (AU); John Colin Schultz, Mawson Lakes (AU)

(73) Assignee: XPED Holding Pty Ltd, Mawson Lakes, SA (AU)

(21) Appl. No.: 14/773,721

(22) PCT Filed: Mar. 5, 2014
(86) PCT No.: PCT/AU2014/000207

§ 371 Date: Sep. 8, 2015

Related U.S. Application Data
(60) Provisional application No. 61/772,666, filed on Mar. 5, 2013.

(51) Int. Cl. G06F 3/0481; G06F 3/0484; G06F 3/0488

(52) U.S. Cl. CPC G06F 3/04817; G06F 3/0488; G06F 3/04842; G06F 3/04847

(57) ABSTRACT

The invention relates generally to remote controls with graphical user interfaces and user input mechanisms that are used to control the state of one or more other devices. The invention includes a meta-state widget provided on a remote control device to indicate a condition of the state of an application widget also on the device. An application widget provides on the remote control a visual icon such as a push button, slider, check box or other kind of icon that commonly appears on a graphical user interface. An application widget may be used to send a command to an associated entity to cause it to change state. In general an associated entity may be a physical device such as a PVR, or a software element such as a program or a component of a program. The conditions that may be indicated on the remote control device by the meta-state widget are: UNCONFIRMED, CONFIRMED, UNKNOWN and IN-ERROR.

### CROSS REFERENCE TO RELATED APPLICATION

This application claims priority from U.S. Provisional Application 61/772666 filed Mar. 5, 2013 the disclosures of which are herein incorporated by reference in their entirety.

### TECHNICAL FIELD

The invention relates generally to remote controls with graphical user interfaces and user input mechanisms that are used to control the state of one or more other devices.

### BACKGROUND

As more devices become remotely controllable, especially over communications links such as Personal Area Networks (PAN), Wireless Local Area Networks (WLAN) and cellular telephone networks, it is a significant challenge to keep the user informed of the true state of the devices they are attempting to monitor and control. This situation is especially important when the user is at a remote location or in a different room to the device being controlled such that they cannot observe whether a command was actioned or not.

The most common remote control technology uses infrared signals over a one way communications link between a controller and a device. In this kind of system, the user, controller and device must be in line of sight of each other and the user is an integral part of the control system. When the user presses a button on the remote control, they observe whether the device changed state to confirm that the command was successful.

A newer generation of wireless controllers and devices are becoming available. One such example is the RF4CE system that uses IEEE 802.15.4 wireless communications technology. Using RF4CE, a user can control a device without being inline of sight of it, as the radio signals can pass through walls. Additionally, the device can also send a response back to the controller indicating whether it actioned the command or not.

Simply replacing infrared technology with Radio Frequency (RF) technology on a push button remote does not make the system more useful with regards to the confirmation of the actioned command. The user may still not know whether a command they issued has been actioned unless they are able to observe the device change state to that which was commanded. To overcome this problem some push button RF remote controls have an LCD screen added to them. Having a screen enables status information about the command to be displayed to the user such as an error message if the command failed to be confirmed by the device. However, this kind of user interface does not allow the user to see the actual state of the device on the remote control. For example the user cannot tell, for example, what level the volume has been set to as a result of the command.

Increasingly computers, smartphones and tablets with suitable apps are being used as remote controls in addition to the many other functions they have. These devices have touch screens, or a screen and a pointing device and are able to display very sophisticated Graphical User Interfaces (GUI) capable of representing many things, including for example, the state of any arbitrarily complex device to the user by way of a rich palette of user interface widgets that may mimic physical controls such as sliders, knobs, gauges, switches and the like. Using a system like this, the state of a variable can be displayed directly on the screen of the controller. So continuing the volume example, instead of, or as well as the device displaying its volume level, the controller may also display the volume level by way of a slider widget for instance.

Such a user interface is a very significant improvement over existing push button infrared remote control. However, displaying the state of a device on a remote controller connected to it via communications link introduces a number of problems. The foremost of these is how to represent to the user the condition of the state, also known as the meta-state. To illustrate the meta-state concept, consider the situation where a user adjusts an on-screen volume slider from 2 to 5 and in response the controller sends a series of commands over a wireless communications link to a device. The slider depicted on the remote control shows the volume is 5, but how does the user know that the volume on the device is also 5? Perhaps the controller is in a marginal communications coverage area and one or more of the commands sent to the device did not get through to the device being controlled. Thus additional information is required that qualifies to the user that what they see on-screen represents the true state of the device or otherwise.

### BRIEF DESCRIPTION OF THE INVENTION

In a broad aspect of the invention includes a meta-state widget provided on a remote control device to indicate a condition of the state of an application widget also on the device. An application widget provides on the remote control a visual icon such as a push button, slider, check box or other kind of icon that commonly appears on a graphical user interface. An application widget may be used to send a command to an associated entity to cause it to change state. In general an associated entity may be a physical device such as a VCR or a software element such as a program or a component of a program. The conditions that may be indicated on the remote control device by the meta-state widget are: UNCONFIRMED, CONFIRMED, UNKNOWN and IN-ERROR.

The UNCONFIRMED condition means that the associated entity has been commanded to change state, but that the change of state has not been confirmed. The CONFIRMED condition means that the associated entity has been commanded to change state and that the change of state has been confirmed. The UNKNOWN condition means that the associated entity has been commanded to change state but that the associated entity has not replied in the requisite amount of time (timed out) or that the associated entity has reported that the state is unknown (could not be determined). The IN-ERROR condition means that the associated entity has been commanded to change state but has replied with an error.

In a further aspect of the invention a meta-state widget may be provided to indicate the condition of a related group of application widgets. For example in an on-screen form where a number of text fields,'checkboxes and other controls contain information and are submitted together as one transaction to an associated entity.

In yet a further aspect of the invention the meta-state widget may provide indications using various means which may be visual or audible or tactile or a combination thereof.

In yet a further aspect of the invention the associated entity may be located on the same device as the graphical user interface or it may be located on a remote device connected by a communications mechanism.

In yet a further aspect of the invention a mechanism may be provided to permit the duration of time (TIMEOUT PERIOD) that is considered too long for an associated entity to respond to a command sent by an application widget to be specified.

Details concerning computers, computer networking, software programming, telecommunications and the like may at times not be specifically illustrated, as such were not considered necessary to obtain a complete understanding nor to limit a person skilled in the art in performing the invention, are considered present nevertheless as such are considered to be within the skills of persons of ordinary skill in the art.

A detailed description of one or more preferred embodiments of the invention is provided below along with accompanying figures that illustrate, by way of example, the principles of the invention. While the invention is described in connection with such embodiments, it should be understood that the invention is not limited to any embodiment. On the contrary, the scope of the invention is limited only by the appended claims and the invention encompasses numerous alternatives, modifications, and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

Although the foregoing invention has been described in some detail for purposes of clarity of understanding, it will be apparent that certain changes and modifications may be practiced within the scope of the appended claims. It should be noted, that there are many alternative ways of implementing both the process and apparatus of the present invention.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The reference to any background or prior art in this specification is not, and should not be taken as, an acknowledgment or any form of suggestion that such background or prior art forms part of the common general knowledge.

“Software,” as used herein, includes but is not limited to one or more computer readable and/or executable instructions that cause a computer or other electronic device to perform functions, actions, and/or behave in a desired manner. The instructions may be embodied in various forms such as routines, algorithms, modules, or programs including separate applications or code from dynamically linked libraries. Software may also be implemented in various forms such as a stand-alone program, a function call, a servlet, an applet, and an application, instructions stored in a memory, part of an operating system or other type of executable instructions. It will be appreciated by one of ordinary skilled in the art that the form of software is dependent on, for example, requirements of a desired application, the environment it runs on, and/or the desires of a designer/programmer or the like.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. Software modules, also known as computer programs, computer codes, or instructions, may contain a number a number of source code or object code segments or instructions, and may reside in any computer readable medium such as a RAM memory, flash memory, ROM memory, EPROM memory, registers, hard disk, a removable disk, a CD-ROM, a DVD-ROM or any other form of computer readable medium. In the alternative, the computer readable medium may be integral to the processor. The processor and the computer readable medium may reside in an ASIC or related device. The software codes may be stored in a memory unit and executed by a processor. The memory unit may be implemented within the processor or external to the processor, in which case it can be communicatively coupled to the processor via various means as is known in the art.

### BRIEF DESCRIPTION OF THE DRAWINGS

FIG. 1 is a block diagram illustrating a controller with a graphical user interface in accordance with some embodiments;

FIG. 2 illustrates a controller with a touch screen graphical user interface in accordance with some embodiments;

FIG. 3 illustrates the components of a system for displaying the meta-state of an application widget that is associated with an associated entity;

FIG. 4 is a flow diagram illustrating the method of indicating the meta-state of an application widget that displays a state of an associated entity;

FIG. 5 illustrates a meta-state widget named ‘Power’ and its associated application widget switch and a meta-state widget named ‘Dimmer’ and its associated application widget control wheel. The meta-state widgets are indicating ‘normal’ condition;

FIG. 6 illustrates a meta-state widget named ‘Power’ and its associated application widget switch and a meta-state widget named ‘Dimmer’ and its associated application widget control wheel. The meta-state widget for the ‘Power’ application widget is indicating ‘changing’ condition;

FIG. 7 illustrates a meta-state widget named ‘Power’ and its associated application widget switch and a meta-state widget named ‘Dimmer’ and its associated application widget control wheel. The meta-state widget for the ‘Power’ application widget is indicating ‘error’ or ‘unknown’ condition; and

FIG. 8 illustrates a meta-state widget named ‘Wi-Fi logon’ and its associated second and third applications widgets named ‘SSID’ and ‘WPA Key’.

### DESCRIPTION OF EMBODIMENTS

The disclosed embodiments relate generally to remote controls with graphical user interfaces and user input mechanisms that are used to control the state of one or more other devices. In this specification, the term device may refer to physical hardware (e.g. a Personal Video Recorded (PVR)) or a suitable light fitting, a software application or a complex system within a suitable computer equipped device.

Embodiments of a multifunction control device, user interfaces for such devices and associated processes for using such devices are described. In some embodiments, the device is a portable device such as a tablet computer or a mobile phone that also contains other functions such as a music player or calendar. The user interface may include a touchscreen or some other human input device such as a keyboard, mouse or even a joystick. However in all embodiments, the device has a display capable of showing a graphical user interface however this is a desirable feature to ease the use and make the user experience better than the alternatives.

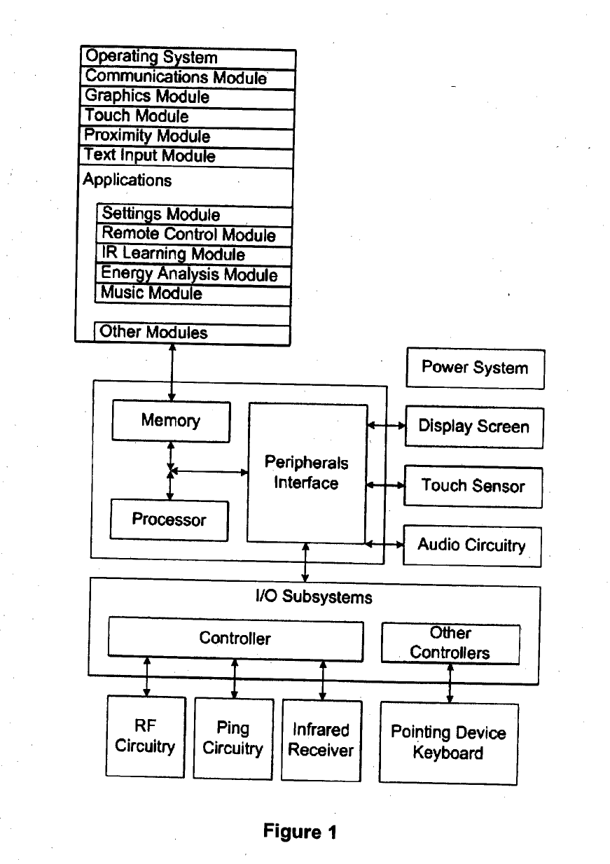

Attention is now directed towards embodiments of the device. FIG. 1 is a block diagram illustrating a multifunction device with a touchscreen. It can be appreciated that the device is only one example of a multifunction device and that it may have more or less components than shown, or may have a different configuration or arrangement of the components. The device may also have various I/O subsystems for interfacing with peripherals. Peripherals may include communications interfaces such as RF Circuitry for wireless communications via a Personal Area Network (PAN) (e.g. 802.15.4, 802.15.1, DASH7, UWB), Wireless Local Area Network (WLAN) (e.g. 802.11 a|b|g|n) or mobile network (e.g. GSM, CDMA, EDGE), Proximity Circuitry for close range communications using the near field over a distance of just a few centimetres (e.g. NFC, Ping), Wired Circuitry for communications over a LAN (e.g. Ethernet) or serial link (e.g. RS232, RS485), human input devices such as joy-stick, mouse and keyboard.

In some embodiments the device may include a screen without a touch surface but with a separate touch pad (not shown). The touchpad may be a touch sensitive surface that is separate from the screen or an extension of the touch screen.

Functions of the device may be implemented by software applications (modules) examples of which may include:

Remote control module,

Activities module.

Such modules will have graphical user interfaces made up of one or more application widgets and-meta-state widgets with their purpose being to provide a user with control over an associated entity and to indicate the condition of an indicated state.

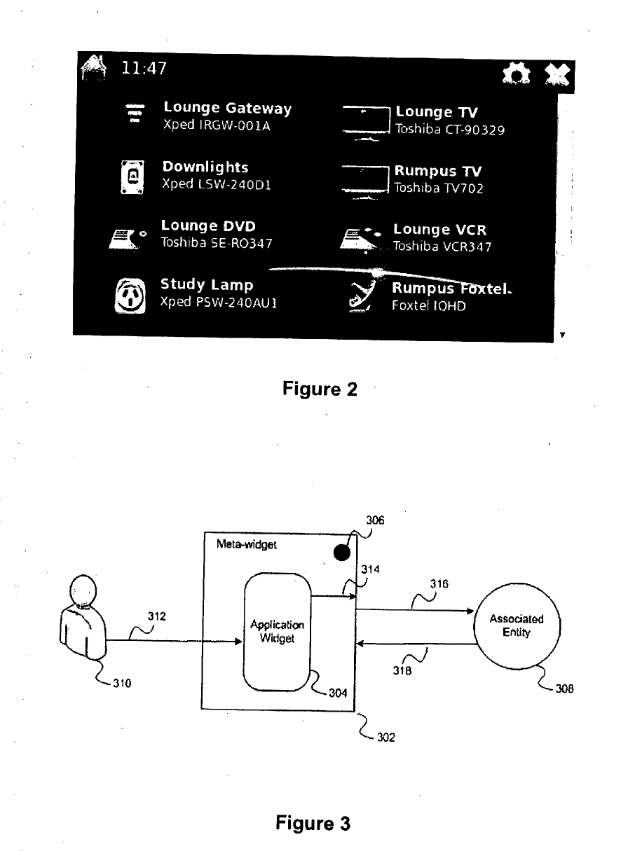

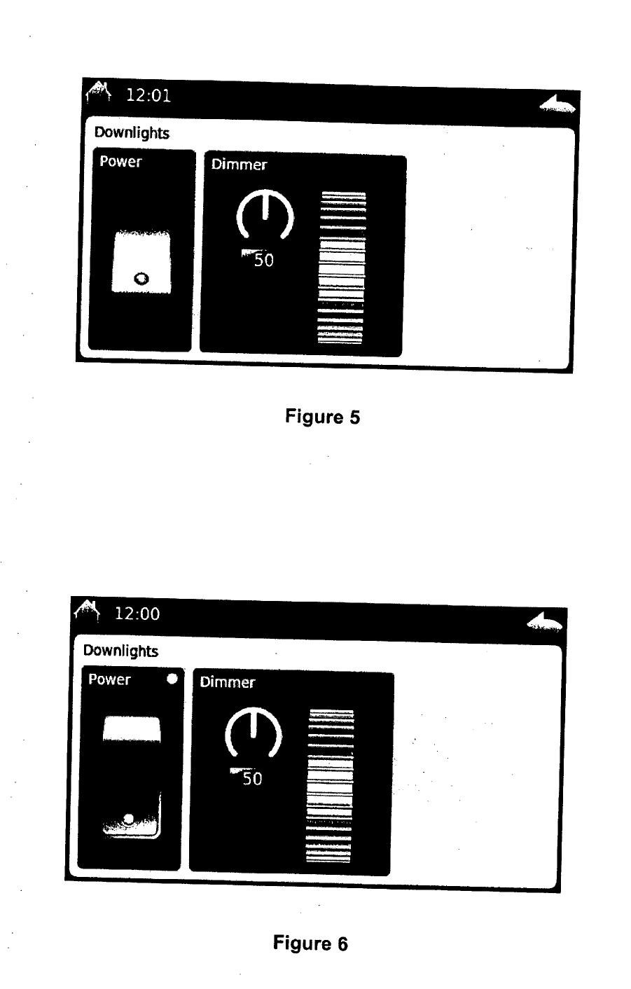

FIG. 2 illustrates a user interface (200) for displaying appliances that are controllable by the device. In some embodiments all the appliances may be displayed on one screen without, scrolling. However as the number of appliances increases, the icons for these appliances may not fit in the visible area of one screen and the user may scroll the display up or down to reveal more icons by using the vertical scroll bar illustrated on the right-hand side of the screen. Alternatively the appliance icons may be spread across multiple screens and the user may reveal these using a swiping gesture or navigation controls (such as a horizontal scroll bar) to move between the screens or partially move the screen left or right to reveal further icons. When the user touches one of the appliance icons, say the one named down-lights (202), the control screen for that device is displayed and may appear similar to the user interface illustrated in FIG. 5.

FIG. 3 illustrates a system for displaying the meta-state of an application widget that is part of a graphical user interface. The application widget (304) displays some condition of an associated entity (308) which may be a physical object or a software object, and is used as a controller to change the state, of the associated entity. A meta-state widget (302) displays the condition of the application widget's state, also known as a meta-state. When a user (310) activates the application widget (304), an indication (314) is sent to the meta-state widget informing it of its change in state. In response the meta-state widget (302) or the application widget (304) may send a command (316) to the associated entity (308) and the meta-state widget (302) will display an indication (306) to the user that the condition of the application widget is not yet confirmed (unknown). If the associated entity (308) sends a reply (318) the meta-state widget can update the indication (306) and the condition of the application widget (304) will change to reflect the true state of the associated entity (CONFIRMED) (308) or display UNKNOWN if the state of the associated entity is not known or IN-ERROR if the associated entity reported a problem or fault.

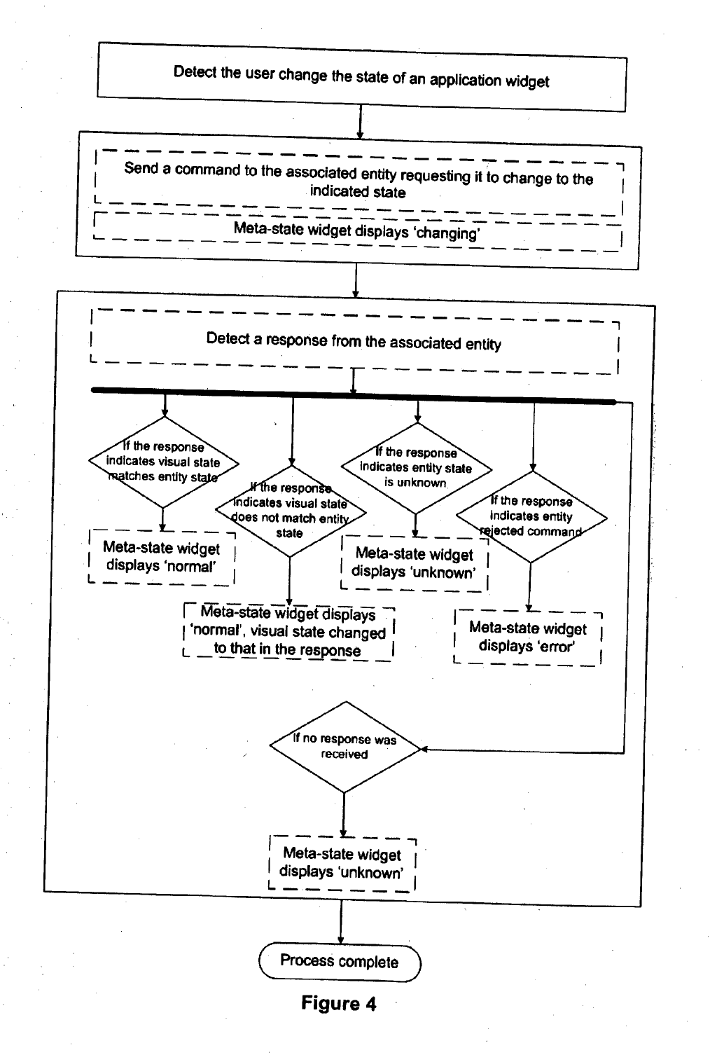

FIG. 4 is a flow diagram illustrating a method of displaying meta-state information associated with an application widget used to represent an element of the state of an associated entity. The method provides a simple visual indicator to a user that the visual state of the associated application widget represents the true state of the associated entity (normal) or that the state of the associated entity is not known (unknown) or that the associated entity reported a problem (error). The conditions indicted by the meta-state widget are merely examples and not necessarily all possible conditions and there may be situations when a smaller number of meta-states are tested, received and/or indicated to the user.

The on-screen state of an application widget is changed by the user. In some embodiments this is done via a touchscreen and in others it may be done using a mouse or other human input device such as voice or not accepted unless accompanied by a biometric test. In response to detecting the state change of an application widget (402), a command is sent to the associated entity instructing it to change its state to the requested value/state (406) and the meta-state widget associated with the application widget changes its condition indication to UNCONFIRMED (408) to indicate to the user that the visual state of the application widget is not yet confirmed as a change of state of the associated entity or to represent the actual state of the associated entity.

If the associated entity receives the command it will process it and send a reply. In response to detecting the reply from the associated entity (412), if the reply indicates that the visual state of the application widget matches the state of the associated entity (414), the meta-state widget changes its state to CONFIRMED (416); if the reply indicates that the visual state of the application widget does not match the state of the associated entity (418), the visual state of the application widget is changed to match the reported state and the meta-state widget changes to indicate CONFIRMED (420); if the reply indicates that the state of the associated entity is unknown or cannot be determined (422), the meta-state widget changes to indicate UNKNOWN (424); if the reply indicates that the command was rejected by the associated entity (426), the meta-state widget changes to indicate IN-ERROR (428); if , no reply is received (430) then the meta-state widget changes to indicate UNKNOWN (432).

FIG. 5 illustrates a user interface that contains an application widget for switching power on and off (502), an application widget for dimming the power (506), a meta-state widget (504) to display the condition of application widget (502) and a meta-state widget (508) to indicate the condition of the application widget (506). In this example, via the absence of any indications, both meta-state widgets indicate that the visual state of their associated application widgets is displaying the correct state of their associated entities (CONFIRMED). It is to be noted that a meta-state widget can oversee multiple application widgets. This is a great advantage since there can be a multitude of application widgets that control an equally large number of associated entities which would otherwise need to have the interfaces to them to confirm their state, whereas the one meta-state widget can deal with this situation.

FIG. 6 illustrates the same user interface disclosed in FIG. 5 however in this case the meta-state widget (504) is indicating that the condition of the application widget (502) is UNKNOWN by way of an indication (602) which in this case is a yellow circle.

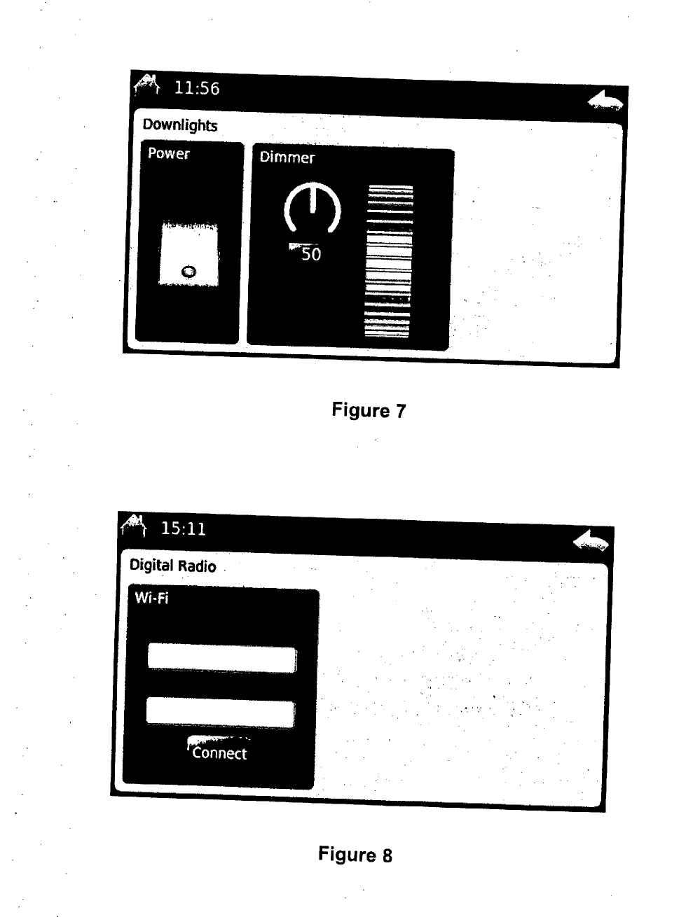

FIG. 7 illustrates the same user interface disclosed in FIG. 5, however in this case the meta-state widget (504) is indicating that the condition of the application widget (502) is IN-ERROR by way of an indication (702) which in this case is a red circle.

FIG. 8 illustrates a user interface that contains a group of related application widgets (802 and 804) and a single meta-state widget (806) for displaying the collective condition of the application widgets (802 and 804). In this case any indication displayed by the meta-state widget applies collectively to all its associated application widgets.

1. A computer implemented control and indicating method performed by a controller having a processor and a graphical user interface and associated user input mechanism for controlling an associated entity, the steps of the method including:
a) displaying a meta-state widget for displaying on the graphical user interface at least one state of an associated entity controlled by an application widget, where the meta-state widget indicates a condition of the state of the application widget;
b) displaying an application widget for displaying on the graphical user interface at least one user input mechanism usable by a user to initiate control of an associated entity and display one or more states of the associated entity;
c) detecting by the application widget a user input mechanism initiated change to the application widget to change a state of the associated entity to a requested state;
d) sending a command from the application widget to the associated entity to set the state to the requested state, and setting the meta-state widget to indicate that the state of the application widget is unconfirmed; and
e) receiving a response from the associated entity indicating its state matches the requested state and setting the meta-state widget to indicate that the condition of the state displayed by application widget is confirmed; or
f) receiving a response from the associated entity indicating its state does not match the requested state and setting the meta-state widget to indicate that the condition of the state displayed by the application widget is confirmed and setting the state of the application widget to the indicated state.

2. The method according to claim 1 further including a replacement of step f) of:
f) receiving a response from the associated entity indicating its state is unknown or cannot be determined and setting the meta-state widget to indicate that the condition of the state displayed by the application widget is unknown.

3. The method according to claim 1 further including a replacement of step f) of:
f) receiving a response from the associated entity indicating that the command from the application widget to the associated entity was rejected and setting the meta-state widget to indicate that the condition of the state displayed by the application widget is in error.

4. The method according to claim 1 further including a replacement of steps e) and f) of:
g) receiving no response from the associated entity within a predetermined parameter and setting the meta-state widget to indicate that the condition of the state displayed by the application widget is in unknown.

5. The method according to claim 1 wherein the meta-state widget indicates the meta-state graphically by the use of one or more of the group: colours, shades of grey, patterns, text, icons, symbols, or an animation.

6. The method according to claim 1 wherein the associated entity is physically remote to the device and communications between the controller and the associated entity uses one or more communications mechanisms.

7. The method according to claim 1 wherein more than one application widget are associated with a meta-state widget which indicates the condition of at least one of the application widgets.

8. The method according to claim 1 wherein the meta-state widget indicates a condition of an application widget graphically by the use of one or more of the group: colours, shades of grey, patterns, text, icons, symbols or an animation.

9. A controller device for implementing a control and indicating method, the device including:
a graphical user interface,
a user input mechanism,
one or more processors,
memory; and
one or more widgets, wherein the one or more widgets are stored in the memory and configured to be executed by the one, or more processors, the widgets performing the steps of:
a) displaying a meta-state widget associated with the display on the graphical user interface of at least one state of an associated entity controlled by an application widget, where the meta-state widget indicates a condition of the state of the application widget;
b) displaying an application widget for displaying on the graphical user interface at least one user input mechanism usable by a user to initiate control of an associated entity and display one or more states of the associated entity;
c) detecting by the application widget a user input mechanism initiated change to the application widget to change a state of the associated entity to a requested state;
d) sending a command from the application widget to the associated entity to set the state to the requested state, and setting the meta-state widget to indicate that the state of the application widget is unconfirmed; and
e) receiving a response from the associated entity indicating its state matches the requested state and setting the meta-state widget to indicate that the condition of the state displayed by application widget is confirmed; or
f) receiving a response from the associated entity indicating its state does not match the requested state and setting the meta-state widget to indicate that the condition of the state displayed by the application widget is confirmed and setting the state of the application widget to the indicated state.
